(19) United States
(12) Patent Application Publication
(10) Pub. No.: US 2021/0276515 A1
(43) Pub. Date: Sep. 9, 2021

(54) AUTONOMOUS, NO TOUCH, AUTOMOBILE WASH ASSEMBLY

(71) Applicants: TERRY DUPERON, SAGINAW, MI (US); MITCHELL DELEMEESTER, SAGINAW, MI (US); CEDRIC DALEY, BAY CITY, MI (US); TOM FAYFER, SAGINAW, MI (US)

(72) Inventors: TERRY DUPERON, SAGINAW, MI (US); MITCHELL DELEMEESTER, SAGINAW, MI (US); CEDRIC DALEY, BAY CITY, MI (US); TOM FAYFER, SAGINAW, MI (US)

(21) Appl. No.: 16/807,628

(22) Filed: Mar. 3, 2020

(51) Int. Cl. B60S 3/04; B60S 3/00

(52) U.S. Cl. CPC B60S 3/04; B60S 3/002

(57) ABSTRACT

An autonomous, no touch, automobile wash assembly useful in home garages for washing automobiles. The device can operate over predetermined periods of time to completely wash an automobile without any person having to do any manual labor.

### CROSS REFERENCE TO RELATED APPLICATIONS

To the applicant's knowledge, there are no related applications to this application.

### BACKGROUND OF THE INVENTION

The device of the instant invention deals with an autonomous, no touch, automobile wash assembly useful in home garages for washing automobiles. The device can operate over predetermined periods of time to completely wash an automobile without any person having to do any manual labor.

In modern America, assemblies for washing automobiles are quite common, starting with a simple garden hose and a rag. Commercial wash assemblies however, are more complex, and consist of all types and kinds of equipment.

There have been a number of publications with regard to automobile wash assemblies that could be used at home, for example, in a garage or the like.

On such was assembly can be found in U.S. Pat. No. 5,237,614 that issued May 29, 2001 to Retter in which there is disclosed a vehicle washing system mounted adjacent ceiling of a garage or other similar structure. The system has the various components of car washing and each such component is stored overhead of the vehicle and is retractable after washing.

U.S. Pat. No. 6,372,053 that issued to Belanger et. al. on Apr. 16, 2002 deals with a variable pressure spray type vehicle laundry apparatus in which a carriage is mounted for longitudinal displacement along overhead parallel beams and an inverted L-shape spray arm carrying both horizontally and vertically directed nozzles. The spray component moves along side of either side of the vehicle to wash it.

There is disclosed in U.S. Pat. No. 6,810,889, that issued to Flaxman on Nov. 2, 2004, a vehicle washing apparatus having a frame suspended from the ceiling and adapted for encircling a vehicle. It should be noted that it is the frame that encircles the automobile, not the washing apparatus.

U.S. Pat. No. 7,100,621, that issued to Johnson on Sep. 5, 2006 discloses a sidetrack vehicle washer with rotating spray arm. It should be noted that the apparatus works by having a centrally attached rotating arm that allows for the movement of the spray component around the vehicle.

A portable manual car wash assembly is disclosed in U.S. Pat. No. 8,186,366, that issued May 29, 2012 to Montoya, et. al. It is a portable manual vehicle wash assembly including a base removably attachable to a top exterior surface of a vehicle to which washing materials are supplied.

U.S. Pat. No. 8,333,845 that issued Dec. 18, 2012 to Wentworth, et. al. deals with a vehicle washing system including a frame having an entrance and an exit side. The frame linearly reciprocates along a plurality of rails to allow the frame to travel over a stationary to dispense washing materials to the vehicle.

### BRIEF DESCRIPTION OF THE DRAWINGS

FIG. 1 is a view in perspective of the wash assembly of this invention.

FIG. 2 is an enlarged side view of the spray arm trolley with a portion of the spray piping attached.

FIG. 3 is a full top view of the spray arm trolley shown in FIG. 2.

### DETAILED DESCRIPTION OF THE DRAWINGS

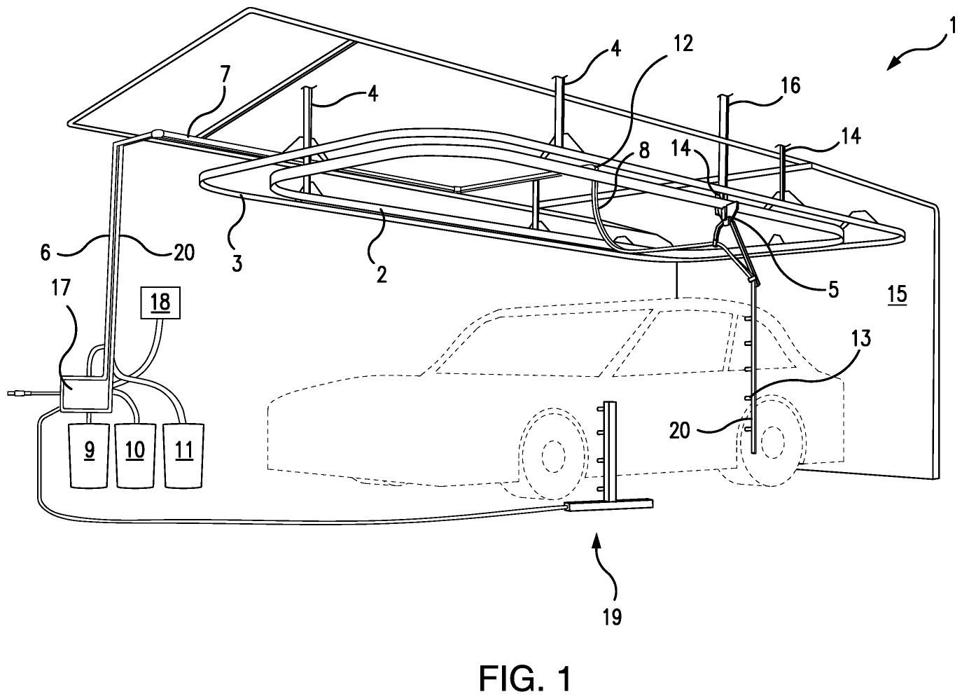

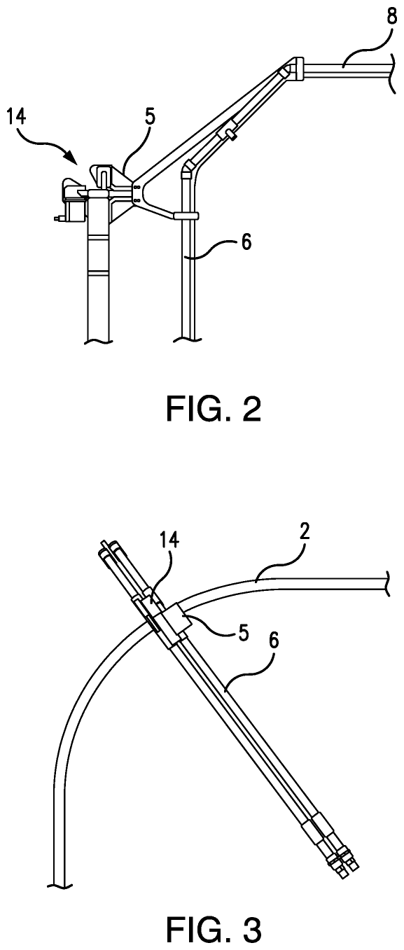

FIG. 1 is a view in perspective of a device of this invention showing an automobile (in phantom) located in the assembly. The automobile is not considered part of this invention.

There is shown in this view the device 1, consisting of a spray arm track 2, a curtain rail 3, brackets 4 holding the spray arm track 2 and the curtain rail 3, to a support system (not shown and not part of the invention). The suspension can be, for example, joists in a garage. Located on the spray arm track 2 is a spray arm trolley 5. The spray arm trolley 5 is configured to move along the spray arm track 2 in essentially a circular configuration such that the trolley 5 can move foam 6 and water spray 20 arms around the automobile.

The trolley 5 is moved by an electric stepper motor 14 and the electrical connection 16 of the electric stepper motor 14 can be joined with the piping system 7 or can be independently wired in with its own flexible connections for movement around the spray arm track 2.

The foam 6 and water spray 20 arms are flowably connected to a transport piping system 7 which carries water 20 and foam 6 to the spray arms. At a certain point with the spray arm track 5, the piping connects to hose 8 so that there is flexibility of the system as it moves around the track.

The piping system 7 is further connected to a source for the water and foam material, generally 9. The system 9 is comprised of a soap solution reservoir 10, a quick dry solution reservoir 11, if desired, and contains various valving 17, control system 18 for operating the system 9. This system can be computerized.

The hose 8 at a terminating end 12 connects to foam and water spray arms 13, which are equipped with a plurality of nozzles through which the foam and water reach the automobile. It is contemplated within the scope of this invention to extend the spray 13 to floor level, or to introduce separate spray stations 19 at the floor level to accommodate washing of the wheels. It is also contemplated within the scope of this invention to use devices that will spray underneath the car to remove grime buildup. A curtain 15, (partially shown), can be used to enclose the automobile during the wash and rinse cycles. This curtain can be either automated, or can be manually used.

The device of this invention is designed to operate on a predetermined time sequence such that it can take a couple of hours to wash a car, or it can take, for example, overnight.

It should be noted that the device 1 does not operate under high pressure and therefore, does not require pumps or motors at the site of the installation. It operates at the pressure rating of a home water hose, connected to the home water system.

Thus, one can wash a vehicle in an average home garage, remove salt and road grime, extend the life of the vehicle, and reduce vehicle maintenance time. The device has as key features: no-touch foam/water dispensing cycles, low pressure spray and autonomous operation. The size of the unit can vary, but is nominally fits within a 10′×20′×7.5′ enclosure and fits conveniently in a home garage. It is contemplated that the device can works with an overspray containment, that is, an entire enclosure around the automobile, a portion of which is shown at 15. The device is designed to run power at less than 1.2 kW@ 120Volt service.

What is claimed is:

1. An autonomous, no touch, automobile wash assembly, said autonomous, no touch, automobile wash assembly comprising in combination:
(A) a supportable, continuous, metal, spray arm track, said supportable, continuous, metal, spray arm track having movably attached thereto a spray arm trolley, said trolley being mobile on said track powered by an electric stepper motor;
(B) a water and detergent delivery assembly, said water and detergent delivery assembly comprising:
i. a soap reservoir,
ii. a water source,
iii. at least one spray arm, and,
iv. piping connected to said soap reservoir, said water source, and said spray arm, any such said spray arm containing delivery nozzles.

2. An autonomous, no touch, automobile wash assembly as claimed in claim 1 wherein, in addition, there is present a curtain rail having the same contour as said continuous, metal, spray arm track.

3. An autonomous, no touch, automobile wash assembly as claimed in claim 1 wherein, said water and detergent delivery system has, in addition, a quick dry solution reservoir.

4. An autonomous, no touch, automobile wash assembly as claimed in claim 2 wherein, in addition, said supportable, continuous, metal, spray arm track and said curtain rail are supported by brackets and overhead support structures.

5. An autonomous, no touch, automobile wash assembly as claimed in claim 1 wherein, in addition, there is present a collection mat for placing beneath said automobile to collect waste water.

6. An autonomous, no touch, automobile wash assembly as claimed in claim 1 wherein, in addition, said stepper motor is electrically powered.

7. An autonomous, no touch, automobile wash assembly as claimed in claim 1 wherein, in addition, said wash assembly is configured to have alternate wash and rinse cycles.

8. An autonomous, no touch, automobile wash assembly as claimed in claim 7 wherein, in addition, there is an additional alternating cycle of quick dry solution application.

9. An autonomous, no touch, automobile wash assembly as claimed in claim 1 wherein, wherein in addition, there is a heating unit for drying said automobile after the wash and rinse cycles.

10. An autonomous, no touch, automobile wash assembly as claimed in claim 1 wherein, in addition, there is present a ventilation system.

11. An autonomous, no touch, automobile wash assembly as claimed in claim 1 wherein, in addition, there is a curtain mounted on said curtain rail that when closed, completely eliminates overspray of said was assembly operation.
